(19) United States
(12) Patent Application Publication
(10) Pub. No.: US 2020/0353509 A1
(43) Pub. Date: Nov. 12, 2020

(54) DEVICE AND A METHOD FOR SORTING SPHERICAL OBJECTS

(71) Applicant: International Tobacco Machinery Poland Sp. z o.o., Radom (PL)

(72) Inventors: Radoslaw FIGARSKI, Radom (PL); Krzysztof STOLARSKI, Radom (PL); Robert SKIERCZYNSKI, Radom (PL)

(73) Assignee: International Tobacco Machinery Poland Sp. z o.o., Radom (PL)

(21) Appl. No.: 16/853,459

(22) Filed: Apr. 20, 2020

(30) Foreign Application Priority Data
May 9, 2019 (EP) 19173412.8

(51) Int. Cl. B07B 13/11; B07B 13/00; B07C 5/36; B07C 5/34

(52) U.S. Cl. CPC B07B 13/11; B07B 13/003; B07C 2501/0018; B07C 5/34; B07C 5/366

(57) ABSTRACT

A device for sorting spherical objects, the device comprising: a feeder for feeding the spherical objects; and a sorting plate comprising a receiving region for receiving the spherical objects and a sorting region comprising a good objects transferring region for transferring good spherical objects and a defective objects transferring region for transferring defective spherical objects.

### TECHNICAL FIELD

The present disclosure relates to sorting spherical objects.

### BACKGROUND

A device as described herein may be used for sorting different types of spherical objects, such as uniform or multi-part objects, solid or partially empty objects, objects comprising one material coated by another material or other types of such objects. The device is particularly useful when there is a need for fast sorting of spherical objects to select objects corresponding with certain requirements in terms of uniformness of an outer surface and/or distribution of the internal mass.

The present disclosure presents the device in relation to an example related to sorting capsules used in tobacco industry, i.e. spheres having a stiff coating filled with aromatic substances. However, such device may be used for all other types of spherical objects.

There are known various devices for sorting spherical objects. A JP1999319728A patent application discloses a device for sorting having an inclined plate, which is inclined such as to separate good and faulty objects, wherein they fall into different containers located at plate edges, wherein good and defective objects move only downwards.

### SUMMARY

The object of the invention is a device for sorting spherical objects, the device comprising: a feeder for feeding the spherical objects; and a sorting plate comprising a receiving region for receiving the spherical objects and a sorting region, the sorting region comprising a good objects transferring region for transferring good spherical objects and a defective objects transferring region for transferring defective spherical objects; characterized in that the sorting plate comprises a sorting surface that ascends between the receiving region and the good objects transferring region.

The sorting surface of the sorting plate may descend between the receiving region and the defective objects transferring region.

The sorting plate may comprise an accelerating region between the receiving region and the good objects transferring region.

The accelerating region may have a form of a feeding duct formed by the sorting surface of the sorting plate and by a rail located on the sorting surface.

The accelerating region may be located upstream of the receiving region.

The accelerating region may be located upstream of the sorting plate.

The accelerating region may be formed by a tube.

The sorting plate may have a form of a gutter element, wherein the good spherical objects move from the receiving region transversally through the gutter element to the good objects transferring region, and the defective spherical objects move downwards the sorting plate to the defective objects transferring region.

The sorting surface may comprise a section of a cylinder, wherein the sorting surface is located such that generating lines of the section of the cylinder are directed towards the defective objects transferring region.

The sorting surface may comprise a section of a cylinder, wherein the sorting surface is located such that generating lines of the section of the cylinder are directed transversally to a feeding duct, wherein the generating lines of the cylinder are inclined from a horizontal direction downwards below the feeding duct.

The sorting plate may have an adjustable angular position, such that an edge of the sorting plate that adjoins the good objects transferring region may change its position in a vertical direction.

The feeding duct may have an angular position that is adjustable with respect to a horizontal direction.

The angular position of the feeding duct may be adjustable along with the angular position of the sorting plate.

The sorting plate may have an angular position that is adjustable in a plane transversal to the feeding duct.

The feeder may comprise a feeding drum that has on its circumferential surface sockets for transferring the spherical objects and a storage of the spherical objects located above the feeding drum.

The feeding drum may have a circumferential groove that passes through the sockets, and wherein an ejector is located in the circumferential groove for ejecting the spherical objects from the sockets.

A negative pressure may be supplied to the sockets.

There is also disclosed a method for sorting spherical objects, the method comprising the steps of: feeding the spherical objects from a feeder onto a sorting plate, wherein the sorting plate comprises a receiving region for receiving the spherical objects and a sorting region, the sorting region comprising a good objects transferring region for transferring good spherical objects and a defective objects transferring region for transferring defective spherical objects; receiving the good spherical objects from the good objects transferring region and receiving defective spherical objects from the defective objects transferring region; characterized by: positioning the sorting plate such that a sorting surface of the sorting plate ascends between the receiving region and the good objects transferring region.

The method may further comprise changing the configuration of the sorting plate during the sorting by means of at least one of the following methods:
changing a vertical position of an edge of the sorting plate that is adjacent to the good objects transferring region;
changing an angular position of a feeding duct for feeding the spherical objects with respect to a horizontal direction;
changing an angular position of both a sorting plate and a feeding duct for feeding the spherical objects with respect to a horizontal direction;
changing an angular position of the sorting plate in a plane which is transversal to a feeding duct for feeding the spherical objects.

The device according to the invention has a simple construction and may be easily utilized for sorting objects of different sizes and weights.

### BRIEF DESCRIPTION OF FIGURES

The present invention is shown by means of example embodiments in a drawing, in which:

FIG. 1 presents a device for sorting in a first embodiment in a side view;

FIG. 2 presents the device for sorting in the first embodiment in a top view;

FIG. 3 presents the device for sorting in a second embodiment in a side view;

FIG. 4 presents the device for sorting in the second embodiment in a top view;

FIG. 5 presents the device for sorting of FIGS. 3 and 4 after angular adjustment of a sorting plate;

FIG. 6 presents the device for sorting in a third embodiment in a top view;

FIG. 7 presents the device for sorting in a fourth embodiment in a side view; and

FIG. 8 presents the device for sorting in a fifth embodiment in a side view.

### DETAILED DESCRIPTION

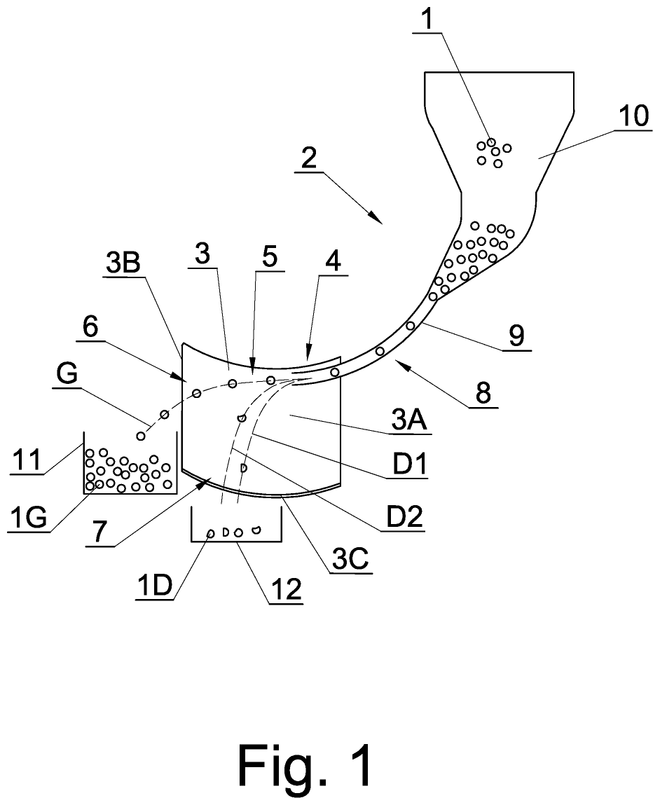

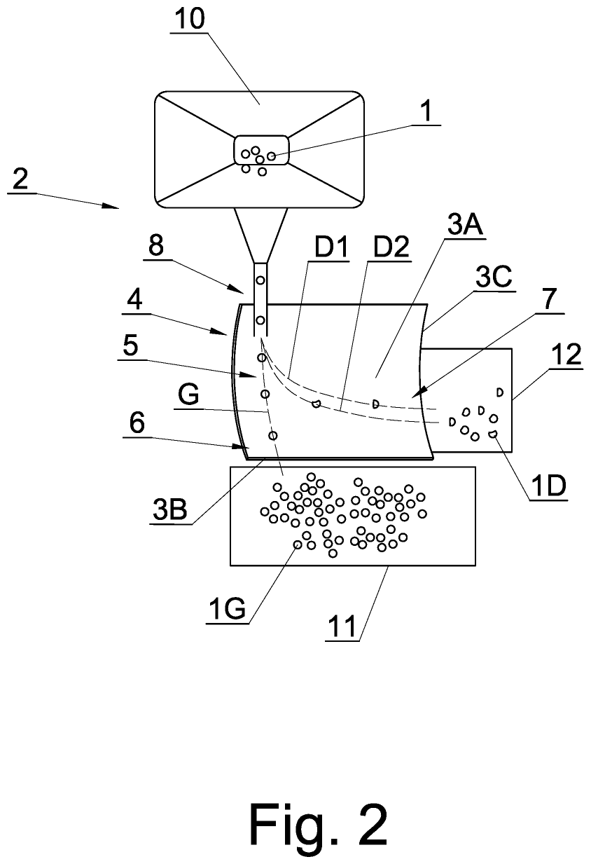

A device for sorting spherical objects 1 is presented in a first embodiment in FIGS. 1 and 2. The device comprises a feeder 2 for feeding the spherical objects 1 and a sorting plate 3. The sorting plate 3 comprises a receiving region 4 for receiving the spherical objects 1 from the feeder 2 and a sorting region 5. The sorting region 5 comprises a good objects transferring region 6 for transferring good spherical objects 1G and a defective objects transferring region 7 for transferring defective spherical objects 1D. At least a portion of a sorting surface 3A of the sorting plate 3 ascends between the receiving region 4 and the good objects transferring region 6. Preferably, the good objects transferring region 6 is located substantially above the receiving region 4, wherein a height level of the receiving region 4 may be referenced in relation to the height level of a point for receiving the spherical objects 1 from the feeder 2. An accelerating region 8 is located upstream (according to the direction of flow of the spherical objects 1) of the receiving region 4. While moving along the accelerating region 8, the spherical objects 1 gain kinetic energy that is useful in the sorting process. In this embodiment, the accelerating region 8 is a feeding duct 9 in a form of a tube that delivers the spherical objects 1 from a storage 10 of the feeder 2. The sorting plate 3 may have a form of a low trough element—in this embodiment the sorting plate 3 has a form of a cylindrical section, wherein generating lines of the cylinder are located transversally to the feeding duct 9 downwards to the defective objects transferring region 7. The sorting surface 3A of the sorting plate 3 in the sorting region 5 descends between the receiving region 4 and the defective objects transferring region 7, i.e. the defective objects transferring region 7 is located below the receiving region 4.

The device for sorting the spherical objects 1 comprises a good objects container 11 for receiving the good spherical objects 1G, which is located below the good objects transferring region 6, as well as a defective objects container 12 for receiving the defective spherical objects 1D, which is located below the defective objects transferring region 7. The good spherical objects 1G, which attained a certain velocity, roll along the sorting region 5 towards the good objects transferring region 6, pass an edge 3B that is adjacent to the good objects transferring region 6 and fall into the good objects container 11. The defective spherical objects 1D may have a non-spherical surface, for example may be elongated, indented, chipped, empty, or may be glued to each other or may have a non-uniform distribution of the internal mass. Such defective spherical objects 1D, even though they attained some kinetic energy, may during their travel change their trajectory away from the trajectory expected for the good spherical objects 1G. Consequently, the defective spherical objects 1D do not reach the good objects transferring region 6, their velocity decreases, and consequently they slide or roll downwards to the defective objects transferring region 7, pass an edge 3C and fall into the defective objects container 12. Dashed lines present examples of trajectories of the spherical objects, wherein a line G presents the trajectory of the good spherical object 1G, and lines D1 and D2 present trajectories of the defective spherical objects 1D. The actual trajectories of the good spherical objects 1G and the defective spherical objects 1D depend on the shape of particular objects, a weight of the objects and a shape of the sorting surface, wherein each defect of the shape of the defective spherical objects 1D may influence the trajectory of movement. The exemplary trajectories G, D1 and D2 are also shown for the other embodiments.

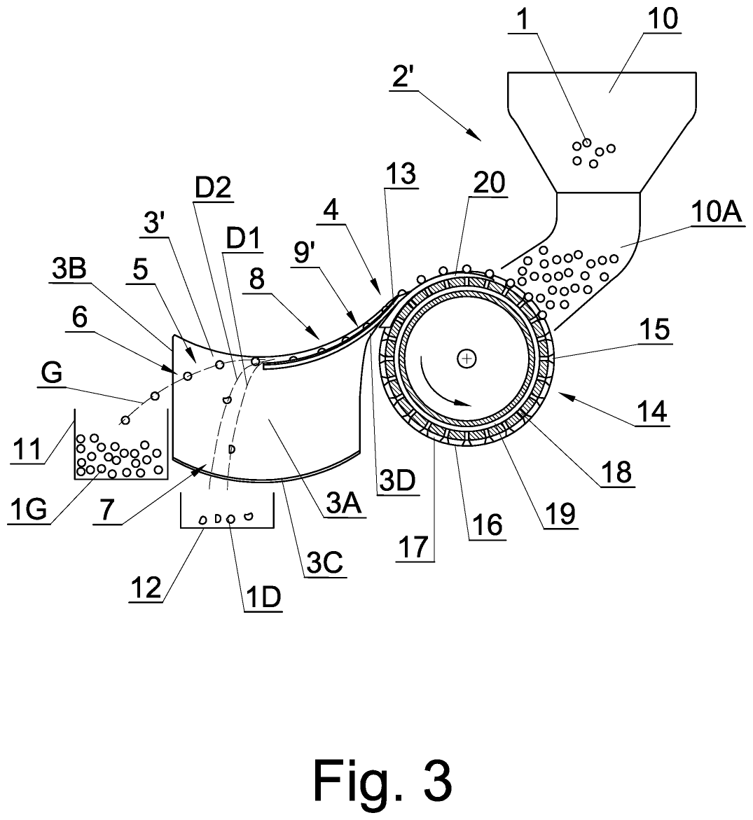

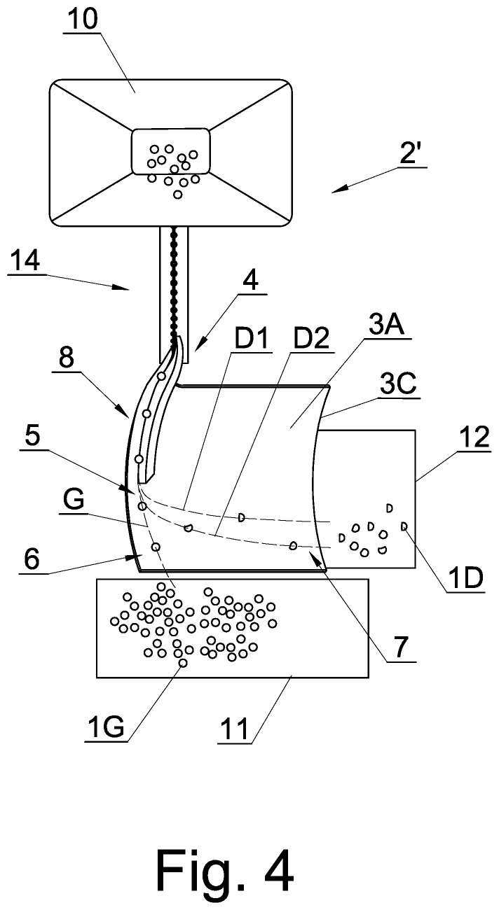

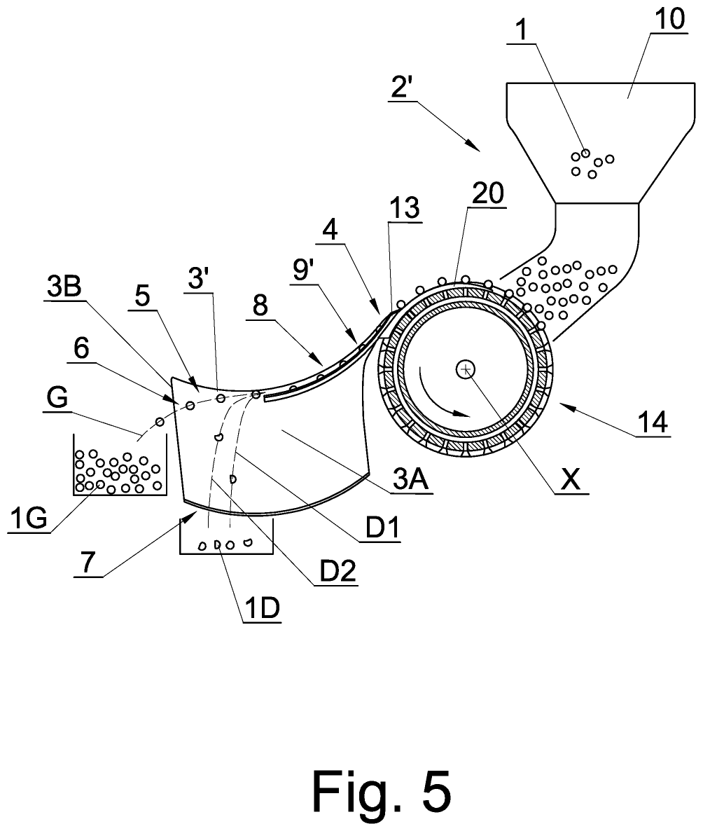

FIGS. 3, 4 and 5 show a second embodiment of a device for sorting spherical objects 1. This device comprises a feeder 2′ for feeding the spherical objects 1 and a sorting plate 3′. The sorting plate 3′ comprises the receiving region 4 for receiving the spherical objects 1 from the feeder 2′ and the sorting region 5, which comprises the good objects transferring region 6 and the defective objects transferring region 7. The sorting surface 3A in the sorting region 5 first descends and subsequently ascends between the receiving region 4 and the good objects transferring region 6. In this embodiment, the accelerating region 8, wherein the spherical objects 1 gain kinetic energy, is defined by the descending portion of the sorting region 5. A feeding duct 9′ is located in the accelerating region 8. The feeding duct 9′ is formed by the sorting surface 3A and a rail 13 having a curvature corresponding to the curvature of the sorting surface 3A and mounted on a surface 13A and on a protrusion 3D. The sorting plate 3 has a shape of a gutter element. The spherical objects 1 attain the kinetic energy, the good spherical objects 1G roll transversally across the sorting plate 3 and reach the good objects transferring region 6, and the defective spherical objects 1D slide down or roll to the defective objects transferring region 7. The feeder 2′ of the spherical objects 1 comprises the storage 10, a duct 10A and a feeding drum 14, from which the spherical objects 1 are transferred to the receiving region 4. The feeding drum 14 has sockets 15 located on its circumferential surface 16. The sockets 15 have a form of indentations, for example conical or spherical indentations, in which the spherical objects 1 are placed. A groove 17 is made in the circumferential surface 16 of the feeding drum 14, wherein the groove 17 passes through the sockets 15. A negative pressure may be supplied to the sockets 15 thorough ducts 18 from a supply duct 19 (the components of the negative pressure supply system are not shown for simplicity of the drawing). An ejector 20, in a form of a flat arc, is inserted into the circumferential groove 17, wherein during the rotation of the feeding drum 14, the ejector is intended to push (eject) the spherical objects 1 out of the sockets 15. FIG. 5 shows the sorting plate 3′ of the device of FIGS. 3 and 4 after performing an angular adjustment by rotating the sorting plate 3′ with respect to an X axis of the feeding drum. During the adjustment, the edge 3B may be lowered or raised with respect to the position presented in FIG. 3 (in FIG. 5, the edge is lowered). Such adjustment may be necessary after changing the weight of the spherical objects, which results in that the spherical objects 1 are given different kinetic energy. Part of the kinetic energy of the good spherical objects 1G is converted into potential energy, and the velocity of the good spherical objects 1G decreases. The adjustment of the height of the edge 3B allows to adapt the operation of the device to sort spherical objects 1 of different weights.

The adjustment of the position of the sorting plate 3 or its components may be performed before starting the sorting, depending on the parameters of the spherical objects 1 being sorted. The adjustment may also be conducted during sorting, based on observation of the spherical objects 1G, 1D which are received from the good objects transferring region 6 and from the defective objects transferring region 7, such as to minimize the amount of the defective objects 1D received from the good objects transferring region 6 and/or to minimize the amount of the good spherical objects 1G received from the defective objects transferring region 7.

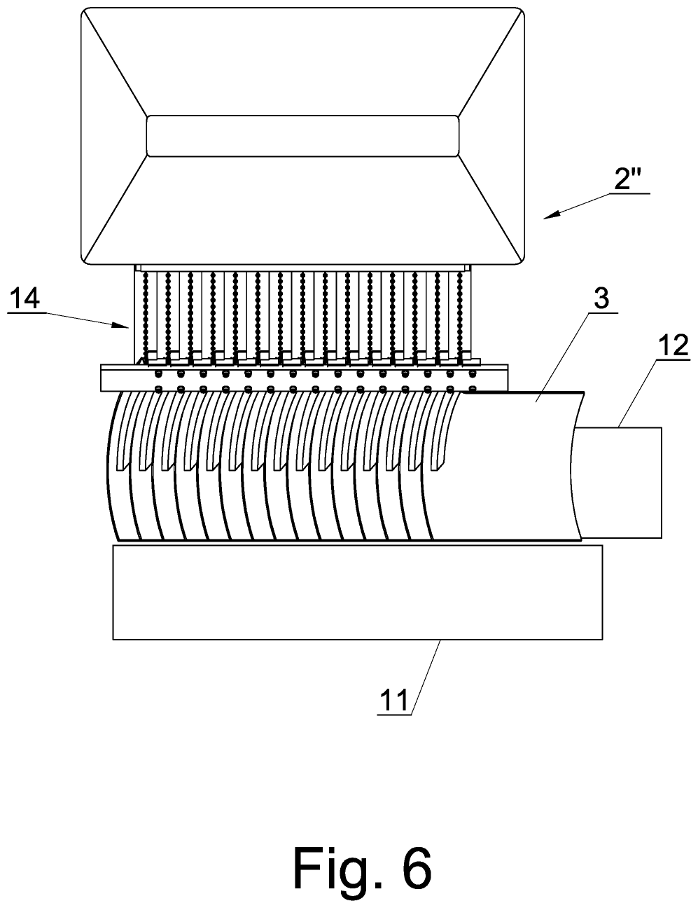

A third embodiment of the device for sorting the spherical objects 1 that is presented in FIG. 6 comprises a plurality of single devices presented in FIGS. 3, 4 and 5. A feeder 2″ of the spherical objects 1 comprises a plurality of feeding drums 14, wherein the spherical objects 1 are fed onto a plurality of sorting plates 3.

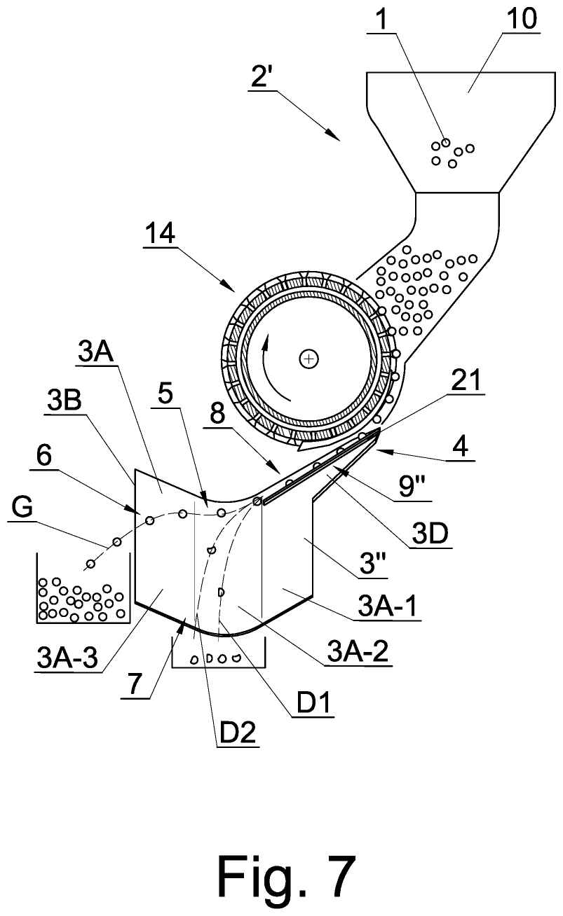

A fourth embodiment of the device for sorting the spherical objects 1 that is presented in FIG. 7 comprises the feeder 2′ of the spherical objects 1 and a sorting plate 3″. The sorting plate 3″ has the receiving region 4 for receiving the spherical objects from the feeder 2′, as well as the sorting region 5, which comprises the good objects transferring region 6 and the defective objects transferring region 7. The sorting surface 3A in the sorting region 5 of the sorting plate 3″ firstly descends and subsequently ascends between the receiving region 4 and the good objects transferring region 6. The sorting surface 3A comprises a first flat portion 3A-1, a second portion 3A-2 being a section of a cylinder and a third flat portion 3A-3. The sorting surface 3A between the receiving region 4 and the good objects transferring region 6 descends along the first flat portion 3A-1 and partly in the second portion 3A-2 and ascends partly in the second portion 3A-2 and in the third flat portion 3A-3. Downstream the receiving region 4 (in the direction of movement of the spherical objects 1 in the region where the sorting surface 3A descends), there is located the accelerating region 8 in which the spherical objects 1 are given kinetic energy, which is necessary for conducting the sorting process. In the accelerating region 8 there is located the feeding duct 9′ formed in the sorting plate 3″ by the flat portion 3A-1 of the sorting surface 3A and the protrusion 3D and the straight rail 13 mounted on the portion of the surface 3A-1 and on the protrusion 3D. The sorting plate 3″ has a shape of a gutter element. The good spherical objects 1G reach the good objects transferring region 6, and the defective spherical objects 1D slide down to the defective objects transferring region 7. The feeder 2′ of the spherical objects 1 and the feeding drum 14 are constructed similarly as in the previous embodiment.

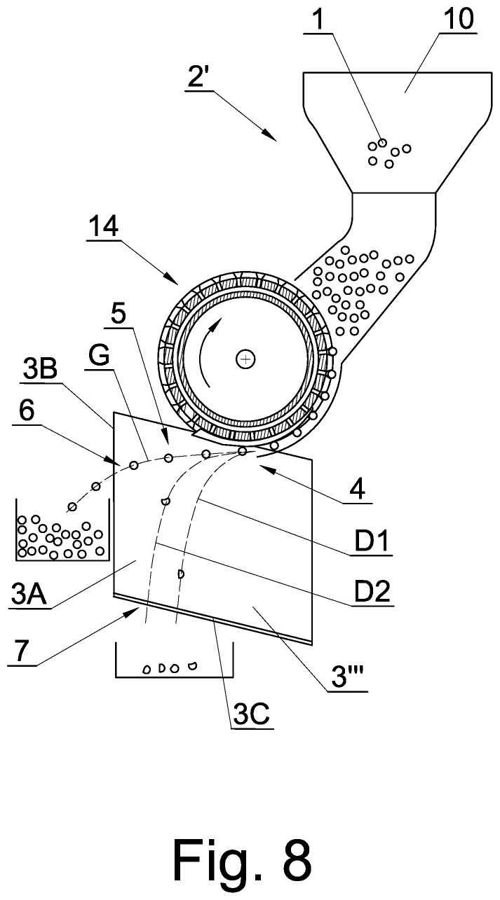

A fifth embodiment of the device for sorting the spherical objects 1 shown in FIG. 8 comprises the feeder 2′ of the spherical objects 1 and a flat sorting plate 3′″. The sorting plate 3′″ has the receiving region 4 for receiving the spherical objects 1, the sorting region 5, which comprises the good objects transferring region 6 and the defective objects transferring region 7. The sorting surface 3A of the sorting plate 3′″ ascends between the receiving region 4 and the good objects transferring region 6. The spherical objects 1 are accelerated by means of a rotary motion of the feeding drum 14, wherein any other feeding drum may be used for feeding the spherical objects 1.

Although the invention is presented in the drawings and the description and in relation to its preferred embodiments, these embodiments do not restrict nor limit the presented invention. It is therefore evident that changes, which come within the meaning and range of equivalency of the essence of the invention, may be made. The presented embodiments are therefore to be considered in all aspects as illustrative and not restrictive. According to the abovementioned, the scope of the invention is not restricted to the presented embodiments but is indicated by the appended claims.

1-15. (canceled)

16. A device for sorting objects, the device comprising:
a feeder for feeding spherical objects; and
a sorting plate comprising a receiving region for receiving the spherical objects, a sorting region comprising a good objects transferring region for transferring good spherical objects and a defective objects transferring region for transferring defective spherical objects, and a sorting surface having a first portion that ascends between the receiving region and the good objects transferring region.

17. The device of claim 16, wherein the sorting surface of the sorting plate has a second portion that descends between the receiving region and the defective objects transferring region.

18. The device of claim 16, wherein the sorting plate comprises an accelerating region (8) between the receiving region and the good objects transferring region.

19. The device of claim 17, wherein the sorting plate comprises an accelerating region (8) between the receiving region and the good objects transferring region.

20. The device of claim 18, wherein the accelerating region includes a feeding duct for feeding the spherical objects and formed by the sorting surface of the sorting plate and a rail located on the sorting surface and having a rail curvature corresponding to a curvature of the sorting surface.

21. The device of claim 17, wherein the accelerating region is located upstream of the receiving region.

22. The device of claim 18, wherein the accelerating region is located upstream of the receiving region.

23. The device of claim 19, wherein the accelerating region is formed by a tube.

24. The device of claim 16, wherein the sorting plate has a form of a trough element, wherein the good spherical objects move from the receiving region transversally through the trough element to the good objects transferring region, and the defective spherical objects move downwards the sorting plate to the defective objects transferring region.

25. The device of claim 24, wherein the sorting surface comprises a section of a cylinder, wherein the sorting surface is located such that generating lines of the section of the cylinder are directed towards the defective objects transferring region.

26. The device of claim 24, wherein the sorting surface comprises a section of a cylinder, wherein the sorting surface is located such that generating lines of the section of the cylinder are directed transversally to a feeding duct, wherein the generating lines of the cylinder are inclined from a horizontal direction downwards below the feeding duct.

27. The device of claim 16, wherein the sorting plate has an adjustable angular position for changing a vertical position of an edge of the sorting plate adjoining the good objects transferring region.

28. The device of claim 17, wherein the sorting plate has an adjustable angular position for changing a vertical position of an edge of the sorting plate adjoining the good objects transferring region.

29. The device of claim 20, wherein the feeding duct has an angular position that is adjustable with respect to a horizontal direction.

30. The device of claim 16, wherein the feeder comprises a feeding drum having a circumferential surface with sockets for transferring the spherical objects from a spherical objects storage region located above the feeding drum.

31. A method for sorting objects, the method comprising the steps of:
feeding spherical objects from a feeder onto a sorting plate, the sorting plate comprising a receiving region for receiving the spherical objects, a sorting region comprising a good objects transferring region for transferring good spherical objects and a defective objects transferring region for transferring defective spherical objects, and a sorting surface having a first portion that ascends between the receiving region and the good objects transferring region; and
sorting the spherical objects into good objects and defective objects.

32. The method of claim 31, further comprising changing the configuration of the sorting plate by changing a vertical position of an edge of the sorting plate adjacent to the good objects transferring region.

33. The method of claim 32, wherein the sorting plate comprises an accelerating region between the receiving region and the good objects transferring region, the accelerating region including a feeding duct for feeding the spherical objects and formed by the sorting surface of the sorting plate and a rail located on the sorting surface and having a rail curvature corresponding to a curvature of the sorting surface; wherein the method further comprises changing the configuration of the sorting plate by changing an angular position of the sorting plate and the feeding duct.

34. The method of claim 32, wherein the sorting plate comprises an accelerating region between the receiving region and the good objects transferring region, the accelerating region including a feeding duct for feeding the spherical objects and formed by the sorting surface of the sorting plate and a rail located on the sorting surface and having a rail curvature corresponding to a curvature of the sorting surface; wherein the method further comprises changing the configuration of the sorting plate by changing an angular position of the sorting plate in a plane which is transversal to the feeding duct.
